(19) United States
(12) Patent Application Publication
(10) Pub. No.: US 2026/0100166 A1
(43) Pub. Date: Apr. 9, 2026

(54) DISPLAY DEVICE

(71) Applicant: LG Display Co., Ltd., Seoul (KR)

(72) Inventors: Ki Tae KWON, Gyeonggi-do (KR); Yong Won JO, Gyeonggi-do (KR); Jong Wook JANG, Gyeonggi-do (KR)

(21) Appl. No.: 19/272,345

(22) Filed: Jul. 17, 2025

(30) Foreign Application Priority Data
Oct. 7, 2024 (KR) 10-2024-0135567

(51) Int. Cl. G09G 3/3266; G09G 3/32; G09G 3/3291

(52) U.S. Cl. CPC G09G 3/3266; G09G 3/32; G09G 3/3291; G09G 2300/0871; G09G 2310/0267; G09G 2310/0275; G09G 2310/08; G09G 2320/0223; G09G 2320/0233; G09G 2330/021

(57) ABSTRACT

A display device includes a pixel array in which a plurality of data lines, a plurality of gate lines, and a plurality of pixels are arranged. A data driver is configured to output data voltages to the plurality of data lines. A gate driver arranged in the pixel array and configured to output gate signals to the plurality of gate lines. A level shifter is configured to generate first and second clock signals for the gate driver. The gate driver includes a first gate driver arranged on odd-numbered column lines and configured to receive the first clock signal. The gate driver also includes a second gate driver arranged on even-numbered column lines and configured to receive the second clock signal.

### CROSS-REFERENCE TO RELATED APPLICATION

Pursuant to 35 U.S.C. § 119(a), this application claims the benefit of an earlier filing date and right of priority to Korean Patent Application No. 10-2024-0135567, filed October, 07, 2024, the contents of which are incorporated by reference in their entirety.

### TECHNICAL FIELD

The present disclosure relates generally to a display device.

### BACKGROUND

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself. This type of display has advantages, such as a response speed is fast, luminous efficiency, large luminance, and a large viewing.

In organic light-emitting display devices, organic light-emitting diodes (referred to as "OLEDs") are formed in each of pixels. These organic light-emitting display devices respond quickly, have excellent light-emitting efficiency, luminance, and viewing angle. They also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like.

### SUMMARY

According to an aspect of the present disclosure, a driver of a display device may include a gate driver that outputs a gate signal. A plurality of gate drivers may be arranged in the pixel array within a display area. Clock lines for applying a start signal and clock signals are connected to the plurality of gate drivers.

However, since the clock lines are connected to the plurality of gate drivers, the number of resistors and capacitors increases in proportion to the number of gate drivers connected to the clock lines, resulting in increased RC delay. As a result, the voltage level of the clock signal may fail to reach the voltage level for the gate driver to operate normally, and thus the gate driver may not operate normally.

The present disclosure is directed to addressing the above-described needs and problems.

The present disclosure provides a display device.

It should be noted that objects of the present disclosure are not limited to the above-described objects, and other objects of the present disclosure will be apparent to those skilled in the art from the following descriptions.

A display device according to implementations of the present disclosure may include a pixel array in which a plurality of data lines, a plurality of gate lines, and a plurality of pixels are arranged; a data driver configured to output data voltages to the plurality of data lines; a gate driver arranged in the pixel array and configured to output gate signals to the plurality of gate lines; and a level shifter configured to generate first and second clock signals for the gate driver, wherein the gate driver comprises: a first gate driver arranged on odd-numbered column lines and configured to receive the first clock signal; and a second gate driver arranged on even-numbered column lines and configured to receive the second clock signal.

A display device according to implementations of the present disclosure may include a pixel array in which a plurality of data lines, a plurality of gate lines, and a plurality of pixels are arranged; a data driver configured to output data voltages to the plurality of data lines; a scan driver arranged in the pixel array and configured to output scan signals to the plurality of gate lines; an EM driver arranged in the pixel array and configured to output emission control signals to the plurality of gate lines; and a level shifter configured to generate clock signals for the scan driver and the EM driver, wherein the EM driver comprises: a first EM driver arranged on odd-numbered column lines and configured to receive a first-phase clock signal; and a second EM driver arranged on even-numbered column lines and configured to receive a second-phase clock signal.

The present disclosure alternately arranges a plurality of gate drivers along column lines for odd-numbered and even-numbered pixel lines, and separates clock lines connected to the alternately arranged gate drivers to apply different clock signals through the separated clock lines, thereby reducing clock line RC delay.

The present disclosure may enable the gate driver to normally output a gate signal by reducing clock line RC delay, thereby reducing power consumption and improving luminance uniformity within a panel.

The present disclosure may increase a pulse width of the clock signal to sufficiently secure a panel design margin and an operation margin of the gate driver.

The present disclosure may enable low-power driving because power consumption may be reduced.

The effects of the present specification are not limited to the above-mentioned effects, and other effects that are not mentioned will be apparently understood by those skilled in the art from the following description and the appended claims.

### BRIEF DESCRIPTION OF THE DRAWINGS

The accompanying drawings, which are included to provide a further understanding of the disclosure and are incorporated in and constitute a part of this application, illustrate implementations of the disclosure and together with the description serve to explain the principle of the disclosure. In the drawings:

FIGS. 1A and 1B are block diagrams showing a display device according to an implementation of the present disclosure;

FIG. 2 is a diagram illustrating an arrangement of the gate drivers shown in FIG. 1B;

FIG. 3 is a diagram illustrating a gate driver according to an implementation of the present disclosure;

FIGS. 4A to 4D are diagrams for explaining operations of a gate driver according to a comparative example;

FIGS. 5A to 5D are diagrams for explaining operations of a gate driver according to a first implementation;

FIG. 6 is a diagram for explaining a principle of generating a clock signal according to the first implementation;

FIG. 7 is a diagram showing gate lines connected to the gate driver shown in FIG. 5A;

FIGS. 8A and 8B are diagrams for explaining operations of a gate driver according to a second implementation;

FIG. 9 is a diagram for explaining a principle of generating a clock signal according to the second implementation;

FIG. 10 is a diagram for comparatively explaining simulation results of a comparative example and the implementations; and

FIGS. 11 and 12 are diagrams showing other arrangement structures of the gate driver.

### DETAILED DESCRIPTION

Modern display devices, such as organic light-emitting diode (OLED) displays, are increasingly deployed in high-performance consumer electronics, automotive systems, and industrial applications. These devices offer thin form factors, fast response times, and high brightness and contrast ratios. In such devices, pixel-driving efficiency and signal timing accuracy are critical to achieving uniform luminance and stable display performance, especially in flexible and high-resolution panel designs.

To support increasingly complex pixel architectures and improve the reliability of panel operation, contemporary display systems often integrate gate drivers and emission control (EM) drivers within the active display area. However, as display resolution and size increase, signal integrity and power efficiency become key challenges. In particular, clock signals distributed across a large array of gate drivers are subject to resistive-capacitive (RC) delays, which degrade signal quality and reduce the margin for reliable gate operation.

Accordingly, implementations of the present disclosure are directed to a display device architecture that reduces RC delay by alternately arranging gate drivers along odd-numbered and even-numbered column lines, and by supplying distinct or phase-offset clock signals through separated clock lines. This arrangement enhances signal integrity across the display panel, improves operational stability of gate and emission control drivers, and contributes to lower power consumption and improved luminance uniformity. These and other aspects of the present disclosure will become apparent with reference to the following implementations and accompanying drawings.

Advantages and features of the present specification and methods of achieving them will become apparent with reference to preferable implementations, which are described in detail, in conjunction with the accompanying drawings. However, the present specification is not limited to the implementations to be described below and may be implemented in different forms, the implementations are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the implementations of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to,’ and the like, one or more other parts may be located between the two parts unless ‘immediately’ or ‘directly’ is used.

Although first, second, and the like are used to describe various components, these components are not limited by these terms. These terms are used to distinguish one component from another. Accordingly, a first component, which is mentioned, below may also be a second component within the technical spirit of the present disclosure.

The same reference numerals may refer to substantially the same elements throughout the present disclosure.

The following implementations can be partially or entirely bonded to or combined with each other and can be linked and operated in technically various ways. The implementations can be carried out independently of or in association with each other.

Hereinafter, various implementations of the present disclosure will be described in detail with reference to the accompanying drawings.

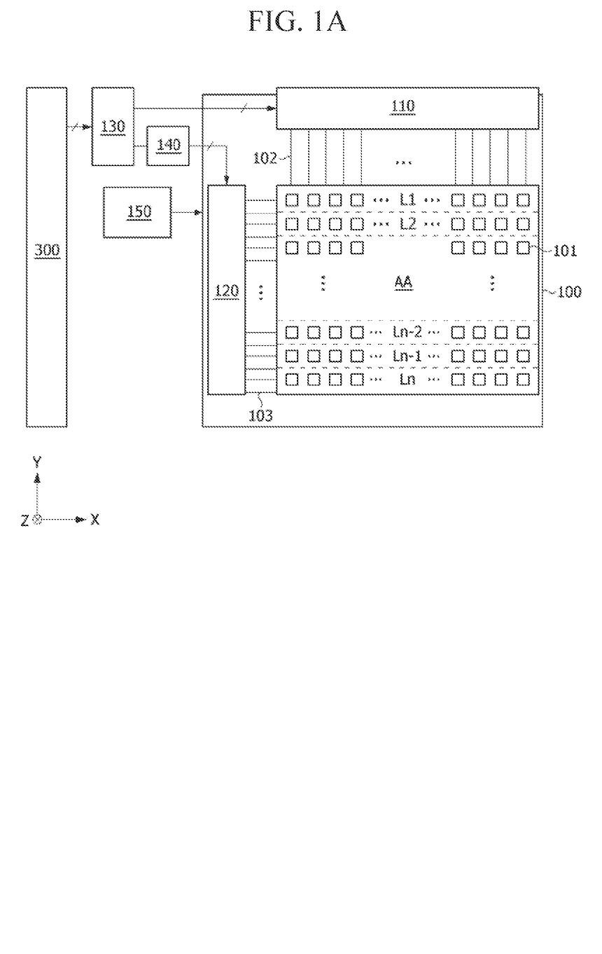

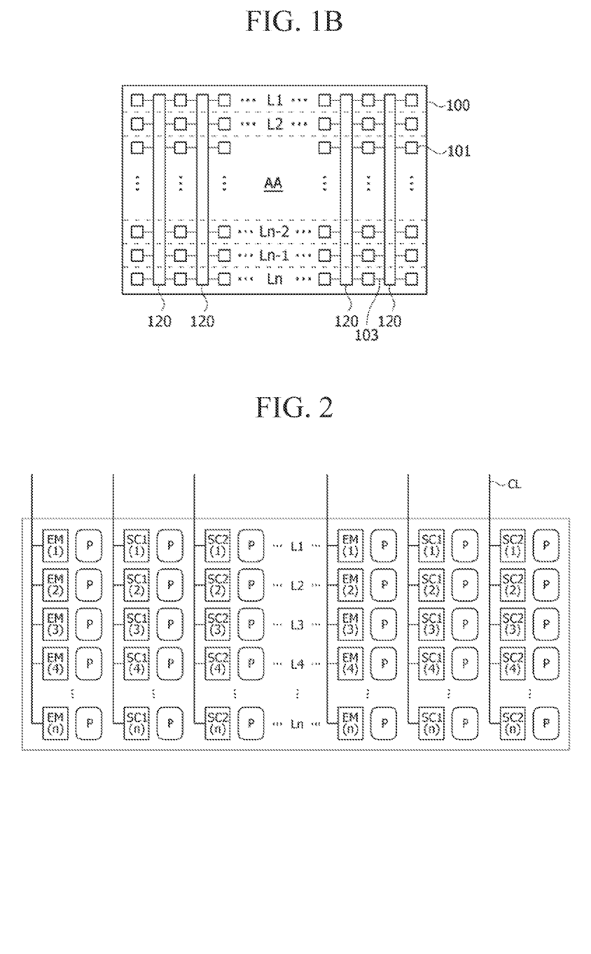

FIGS. 1A and 1B are block diagrams showing a display device according to an implementation of the present disclosure.

Referring to FIGS. 1A to 1B, the display device according to an implementation of the present disclosure includes a display panel 100, and a display panel driving circuit for writing pixel data to pixels of the display panel 100. Additionally, the display device includes a power supply 150.

The display panel 100 may be, but is not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage for driving pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through commonly-connected power lines.

The power supply 150 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator may be implemented with a programmable gamma circuit that may adjust the voltage of each of the gamma reference voltages according to digital data. The timing controller 130, the host system 300, or a separate external device may update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) arranged in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be arranged in at least one of left and right non-display areas NA outside the display area AA in the display panel 100 or at least a part thereof may be arranged within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The gate driver 120 may be arranged in Gate In Panel (GIP) fashion in the non-display area, or in Gate in Active area (GIA) fashion between subpixels SP in the display area AA. For example, as shown in FIG. 1B, the circuit of the gate driver 120 may be located between the pixels 101 within the display area AA.

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The timing controller 130 may analyze the input image for each frame and generate a control signal for selectively outputting gate signals according to the analysis result. The generated control signal may be provided to the shift register of the gate driver 120 through the level shifter 140.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

FIG. 2 is a diagram illustrating an arrangement of the gate drivers shown in FIG. 1B.

Referring to FIG. 2, a gate driver according to an implementation of the present disclosure may include a first scan driver SC1, a second scan driver SC2, and an EM driver EM. The first scan driver SC1, the second scan driver SC2, and the EM driver EM are arranged in the pixel array and may be arranged in different regions.

The first scan driver SC1, the second scan driver SC2, and the EM driver EM may be arranged for each pixel line. For example, a first scan driver SC1(1), a second scan driver SC2(1), and an EM driver EM(1) are arranged on a first pixel line L1, a first scan driver SC1(2), a second scan driver SC2(2), and an EM driver EM(2) are arranged on a second pixel line L2, a first scan driver SC1(3), a second scan driver SC2(3), and an EM driver EM(3) are arranged on a third pixel line L3, a first scan driver SC1(4), a second scan driver SC2(4), and an EM driver EM(4) are arranged on a fourth pixel line L4, and they may be arranged up to an (n)th pixel line Ln.

Here, although a clock line CL for applying a start signal and a clock signal to the first scan driver SC1, the second scan driver SC2, and the EM driver EM is shown as a single line for convenience, it may include a plurality of clock lines. For example, clock lines to which a start signal is applied and clock lines to which two-phase clock signals are respectively applied may be connected to the EM driver EM.

Since a plurality of the same gate drivers are arranged on each pixel line L1 to Ln, a plurality of the first scan drivers SC1, the second scan drivers SC2, and the EM drivers EM may be arranged, respectively.

The same gate drivers arranged on each pixel line are connected to the same gate line. The plurality of first scan drivers SC1 arranged on each pixel line may simultaneously apply a first scan signal to pixels through a first gate line, the plurality of second scan drivers SC2 may simultaneously apply a second scan signal to pixels through a second gate line, and the plurality of EM drivers EM may simultaneously apply an EM signal to pixels through a third gate line.

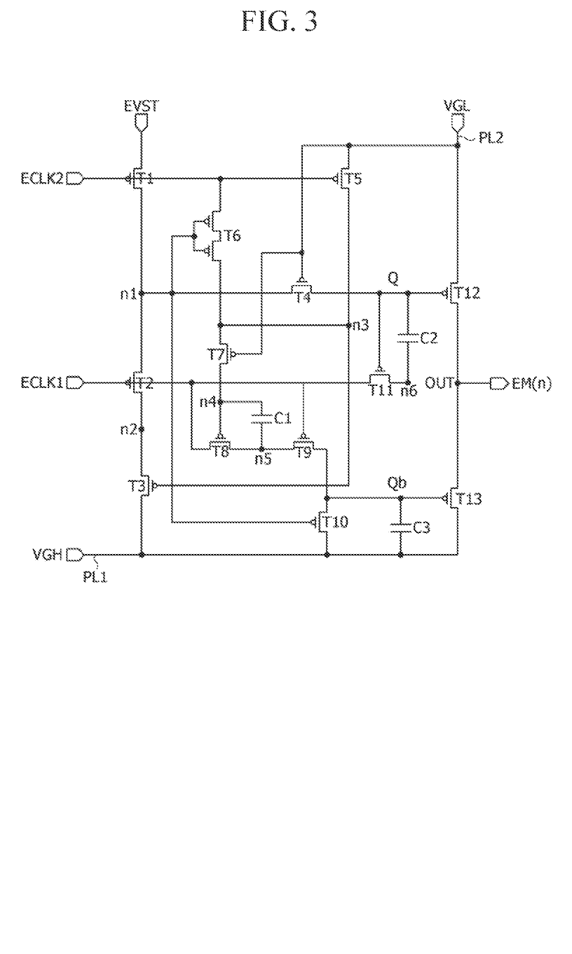

FIG. 3 is a diagram illustrating a gate driver according to an implementation of the present disclosure. Here, the gate driver will be described as an example of the EM driver that outputs the EM signal.

Referring to FIG. 3, a gate driver according to an implementation of the present disclosure may include a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, an eleventh transistor T11, a twelfth transistor or a pull-up transistor T12, a thirteenth transistor or a pull-down transistor T13, a first capacitor C1, a second capacitor C2, and a third capacitor C3.

The first transistor T1 is turned on by a voltage of a clock signal ECLK2 and applies a start signal EVST or a previous carry signal to a first node n1. The first transistor T1 includes a gate electrode to which the clock signal ECLK2 is applied, a first electrode to which the start signal EVST is applied, and a second electrode connected to the first node n1.

The second transistor T2 is turned on by a voltage of a clock signal ECLK1 and connects the first node n1 to a second node n2. The second transistor T2 includes a gate electrode to which the clock signal ECLK1 is applied, a first electrode connected to the first node n1, and a second electrode connected to the second node n2.

The third transistor T3 is turned on by a voltage of a third node n3 and connects a second node n2 to a first power line PL1 to which a high-potential voltage VGH is applied The third transistor T3 includes a gate electrode connected to the third node n3, a first electrode connected to the second node n2, and a second electrode connected to the first power line PL1.

The fourth transistor T4 is turned on by a low-potential voltage VGL and connects a first node n1 to a first control node Q. The fourth transistor T4 includes a gate electrode connected to a second power line PL2 to which the low-potential voltage VGL is applied, a first electrode connected to the first node n1, and a second electrode connected to the first control node Q.

The fifth transistor T5 is turned on by a voltage of a clock signal ECLK2 and connects the second power line PL2 to the third node n3. The fifth transistor T5 includes a gate electrode to which a clock signal ECLK2 is applied, a first electrode connected to a second power line PL2, and a second electrode connected to a third node n3.

The sixth transistor T6 is turned on by a voltage of a first node n1 and applies the clock signal ECLK2 to a third node n3. The sixth transistor T6 includes a gate electrode connected to the first node n1, a first electrode to which the clock signal ECLK2 is applied, and a second electrode connected to the third node n3. The sixth transistor T6 may be implemented as a dual-gate transistor, but is not limited thereto.

The seventh transistor T7 is turned on by a low-potential voltage VGL and connects a third node n3 and a fourth node n4. The seventh transistor T7 includes a gate electrode connected to a second power line PL2, a first electrode connected to a third node n3, and a second electrode connected to a fourth node n4.

The eighth transistor T8 is turned on by a voltage of a fourth node n4 and applies the clock signal ECLK1 to a fifth node n5. The eighth transistor T8 includes a gate electrode connected to the fourth node n4, a first electrode to which the clock signal ECLK1 is applied, and a second electrode connected to the fifth node n5.

The ninth transistor T9 is turned on by a voltage of the clock signal ECLK1 and connects a fifth node n5 and a second control node Qb. The ninth transistor T9 includes a gate electrode to which the clock signal ECLK1 is applied, a first electrode connected to the fifth node n5, and a second electrode connected to the second control node Qb.

The tenth transistor T10 is turned on by a voltage of a first node n1 and connects a first power line PL1 to the second control node Qb. The tenth transistor T10 includes a gate electrode connected to the first node n1, a first electrode connected to the second control node Qb, and a second electrode connected to the first power line PL1.

The eleventh transistor T11 is turned on by a voltage of the first control node Q and applies the clock signal ECLK1 to a sixth node n6. The eleventh transistor T11 includes a gate electrode connected to the first control node Q, a first electrode to which the clock signal ECLK1 is applied, and a second electrode connected to the sixth node n6.

The twelfth transistor T12 is turned on by a voltage of the first control node Q and outputs a low-potential voltage VGL through an output node OUT. The twelfth transistor T12 includes a gate electrode connected to the first control node Q, a first electrode connected to the second power line PL2, and a second electrode connected to the output node OUT.

The thirteenth transistor T13 is turned on by a voltage of the second control node Qb and outputs a high-potential voltage VGH through the output node OUT. The thirteenth transistor T13 includes a gate electrode connected to the second control node Qb, a first electrode connected to the output node OUT, and a second electrode connected to the first power line PL1.

A first capacitor C1 is connected between the gate electrode and a source electrode of the eighth transistor T8. A second capacitor C2 is connected between the gate electrode of the twelfth transistor T12, which is connected to the first control node Q, and a source electrode of the eleventh transistor T11. The second capacitor C2 may be charged by the clock signal ECLK1. The third capacitor C3 is connected between the gate electrode the thirteenth transistor T13 connected to the second control node Qb and a source electrode of the thirteenth transistor T13. The third capacitor C3 may be charged by the high-potential voltage VGH.

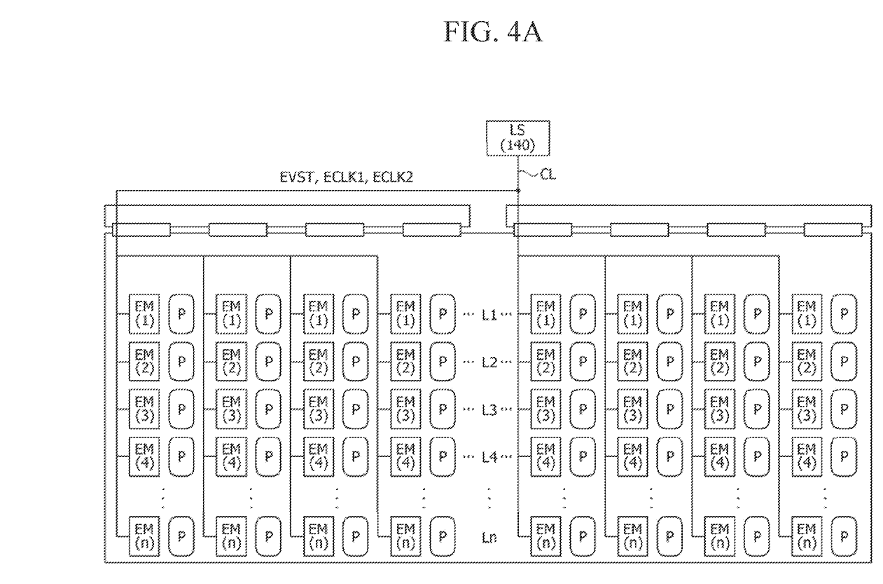

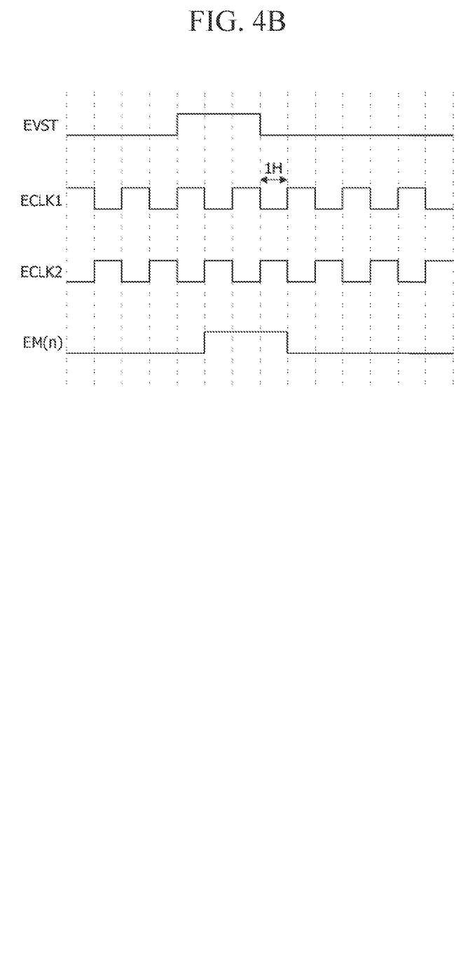

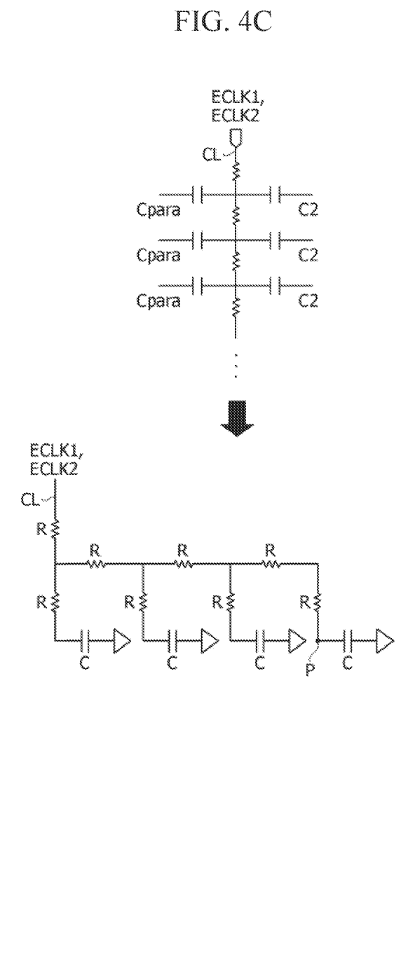

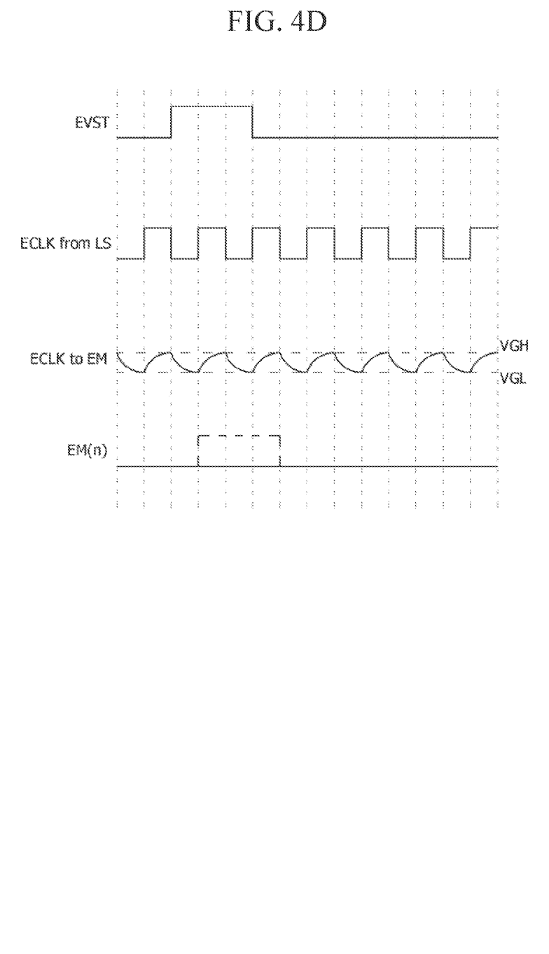

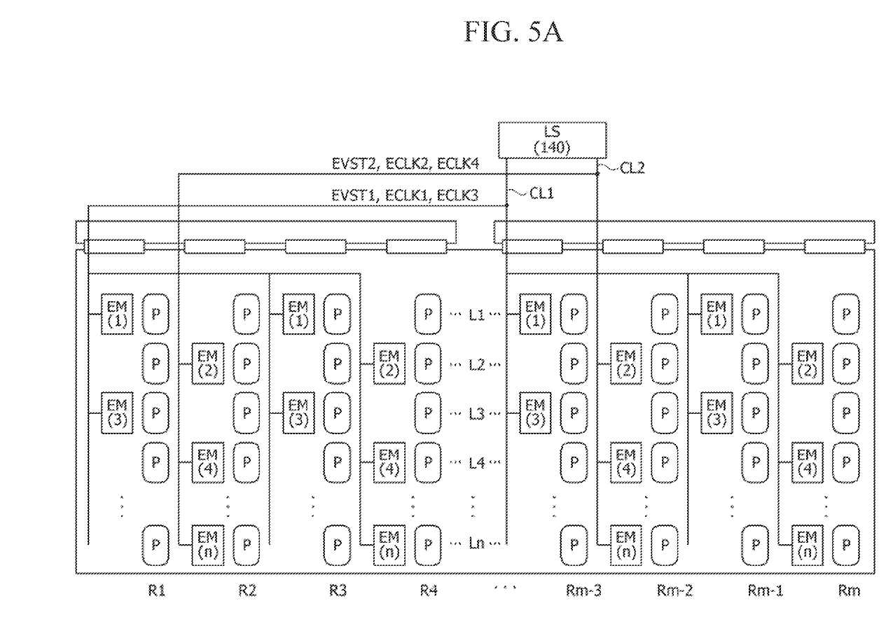

FIGS. 4A to 4D are diagrams for explaining operations of a gate driver according to a comparative example. Here, for convenience of explanation, the arrangement of the EM driver will be described.

Referring to FIGS. 4A to 4D, an EM driver according to a comparative example is arranged in the pixel array within a display area and may be arranged on each pixel line L1 to Ln, and may apply a gate signal EM(n) to pixels P arranged on the corresponding pixel line based on a start signal EVST and clock signals ECLK1 and ECLK2.

In this case, the clock signals ECLK1 and ECLK2 applied to the gate driver EM are used to charge the second capacitor C2 as shown in FIG. 3. Since the second capacitor C2 is present in every gate driver, the greater the number of gate drivers, the greater the number of second capacitors C2 to be charged, and in addition, a parasitic capacitor Cpara generated on a clock line also increases.

Since a plurality of gate drivers EM are present within an active area, as shown in FIG. 4C, resistors R and capacitors C, which include the second capacitor C2 and the parasitic capacitor Cpara, are present for each gate driver EM on the clock line CL to which the clock signals ECLK1 and ECLK2 are applied, causing an increase of RC delay of the clock line CL. As the distance from the point where the clock signal is applied increases, the RC delay becomes larger, and as a result, the RC delay becomes greatest at the farthest point P from the point where the clock signal is applied.

As shown in FIG. 4D, due to the RC delay of the clock line, the clock signals ECLK1 and ECLK2 fail to reach the high-potential voltage VGH and the low-potential voltage VGL for the gate driver to operate normally, and therefore the gate driver fails to normally output a gate signal EM(n).

In a first implementation, a plurality of EM drivers are alternately arranged along column lines for odd-numbered and even-numbered pixel lines in order to separate clock lines to which clock signals are applied.

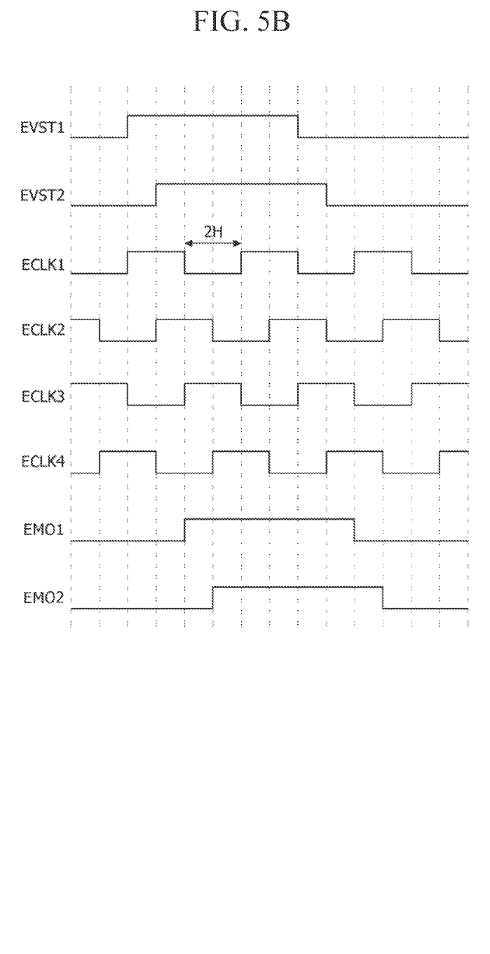

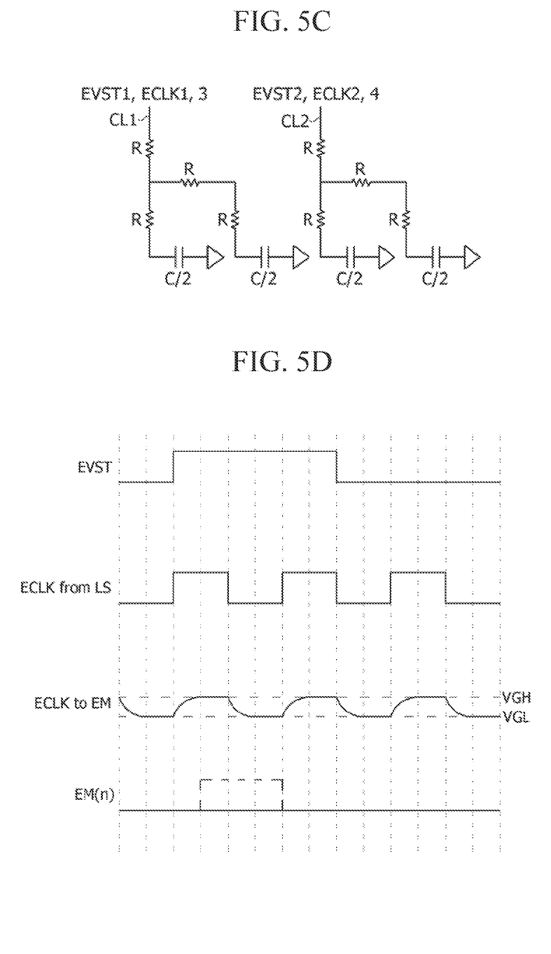

FIGS. 5A to 5D are diagrams for explaining operations of a gate driver according to a first implementation. Here, for convenience of explanation, the arrangement of the EM driver will be described.

Referring to FIGS. 5A to 5D, a gate driver according to the first implementation of the present disclosure includes a plurality of EM drivers EM1 and EM2, and the plurality of EM drivers EM1 and EM2 may be alternately arranged, along column lines R1 to Rm, for odd-numbered and even-numbered row lines or pixel lines L1 to Ln. Here, m and n are natural numbers.

For example, the plurality of EM drivers may include a first EM driver EM1 connected to a first clock line CL1 and a second EM driver EM2 connected to a second clock line CL2.

For example, a plurality of first EM drivers EM1 may be arranged on odd-numbered pixel lines L1 on a first column line R1, a plurality of second EM drivers EM2 may be arranged on even-numbered pixel lines L2 on a second column line R2, a plurality of first EM drivers EM1 may be arranged on odd-numbered pixel lines L3 on a third column line R3, and a plurality of second EM drivers EM2 may be arranged on even-numbered pixel lines L4 on a fourth column line R4.

Different start signals and clock signals may be applied to the first EM driver EM1 and the second EM driver EM2. For example, a first start signal EVST1 and two-phase first clock signals ECLK1 and ECLK3 may be applied to the first EM driver EM1, and a second start signal EVST2 and two-phase second clock signals ECLK2 and ECLK4 may be applied to the second EM driver EM2.

As shown in FIG. 5B, the first start signal EVST1 and the second start signal EVST2 each have a pulse width of 6H, and the first start signal EVST1 may start 1H earlier than the second start signal EVST2.

In addition, the first clock signals ECLK1 and ECLK3 and the second clock signals ECLK2 and ECLK4 each have a pulse width of 2H, and the first clock signals ECLK1 and ECLK3 have a phase difference of 180 degrees from each other, and the second clock signals ECLK2 and ECLK4 also have a phase difference of 180 degrees from each other. The first clock signals ECLK1 and ECLK3 may start 1H earlier than the second clock signals ECLK2 and ECLK4. The first clock signal ECLK1, the second clock signal ECLK2, the first clock signal ECLK3, and the second clock signal ECLK4 have a phase difference of 90 degrees from one another in that order.

Since a plurality of first and second gate drivers are present within an active area and are alternately arranged along column lines for odd-numbered and even-numbered pixel lines, the number of capacitors including the second capacitor C2 and the parasitic capacitor Cpara is reduced by half compared to the number of gate drivers, as shown in FIG. 5C.

In addition, since the four-phase clock signals are applied through two separated clock lines, the resistance of each clock line is reduced by half, and because four-phase clock signals are applied, the period and pulse width of each clock signal increase to 2H, not 1H.

In the gate driver according to the first implementation, since the clock lines are separated into two clock lines, the number of the resistors and capacitors is reduced, and RC delay of the clock lines is also reduced.

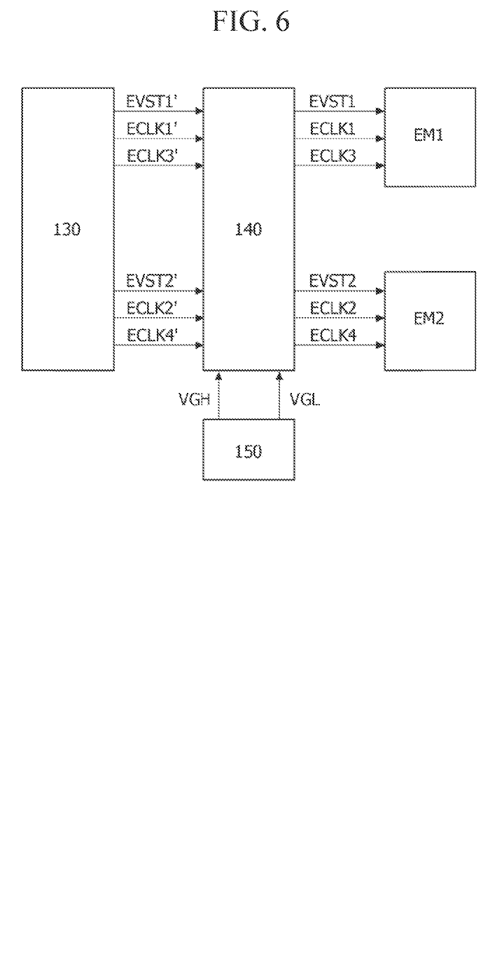

FIG. 6 is a diagram for explaining a principle of generating a clock signal according to the first implementation.

Referring to FIG. 6, a timing controller 130 according to the first implementation may generate a first start signal EVST1', first clock signals ECLK1' and ECLK3' to be applied to a first EM driver, and a second start signal EVST2', and second clock signals ECLK2' and ECLK4' to be applied to a second EM driver, and provide them to a level shifter 140.

The level shifter 140 may amplify the voltage levels of the first start signal EVST1', first clock signals ECLK1' and ECLK3', second start signal EVST2', and second clock signals ECLK2' and ECLK4' provided from the timing controller 130, and supply the amplified first start signal EVST1 and first clock signals ECLK1 and ECLK3 to the first EM driver EM1 through a first clock line, and supply the amplified second start signal EVST2 and second clock signals ECLK2 and ECLK4 to the second EM driver EM2.

In this case, the level shifter 140 may be implemented as a first level shifter that generates the first clock signals and a second level shifter that generates the second clock signals, but is not limited thereto.

A power supply 150 may supply a high-potential voltage VGH and a low-potential voltage VGL to the level shifter 140.

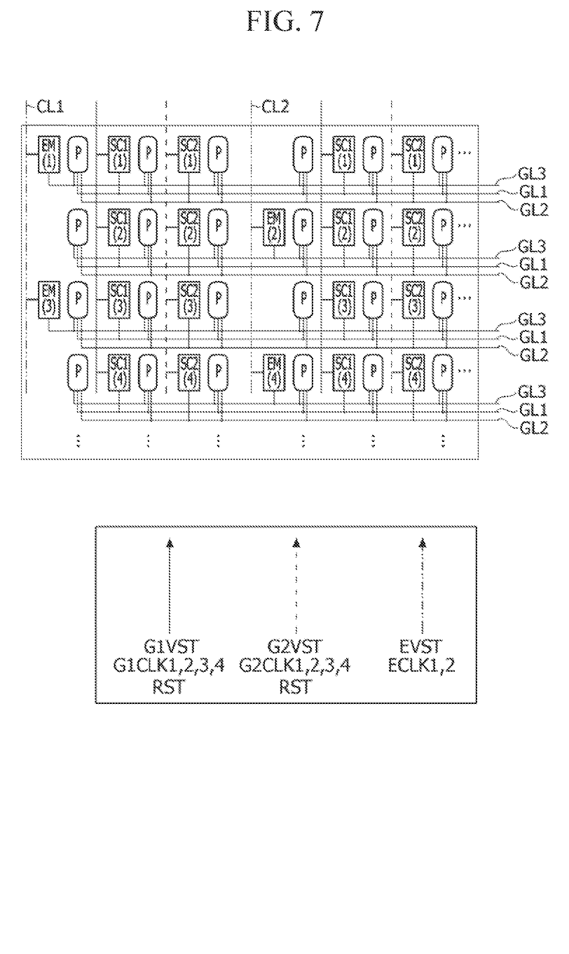

FIG. 7 is a diagram showing gate lines connected to the gate driver shown in FIG. 5A.

Referring to FIG. 7, a gate driver according to an implementation of the present disclosure may include a first scan driver SC1, a second scan driver SC2, and an EM driver EM. The first scan driver SC1 and the second scan driver SC2 may be arranged for each pixel line, and the EM driver EM may be alternately arranged for each pixel line along column lines.

For each pixel line, a plurality of first scan drivers SC1 may be commonly connected to a first gate line GL1, second scan drivers SC2 may be commonly connected to a second gate line GL2, and EM drivers EM may be commonly connected to a third gate line GL3.

In a second implementation, clock lines for applying clock signals to a plurality of EM drivers are separated, and different clock lines are applied depending on the column line in which the EM drivers are arranged.

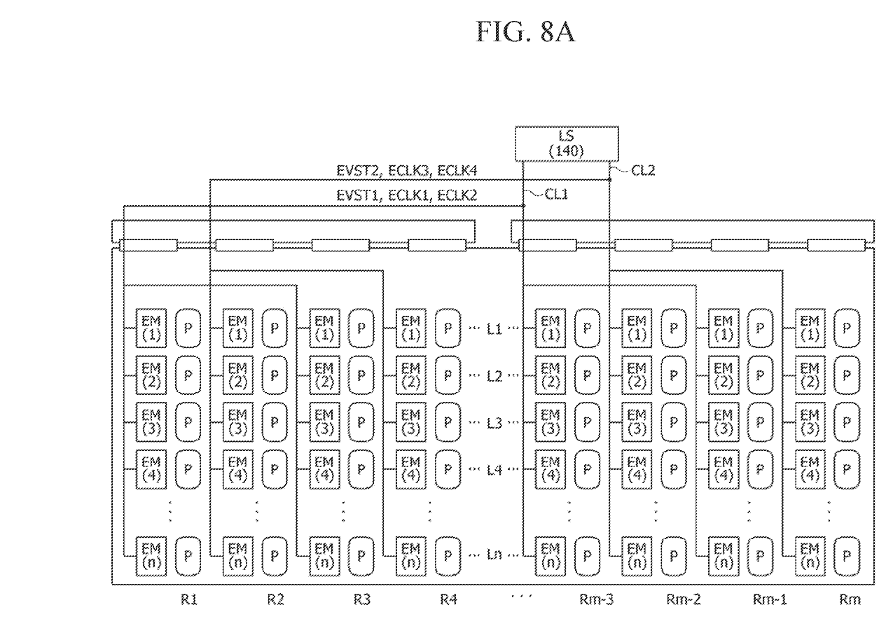

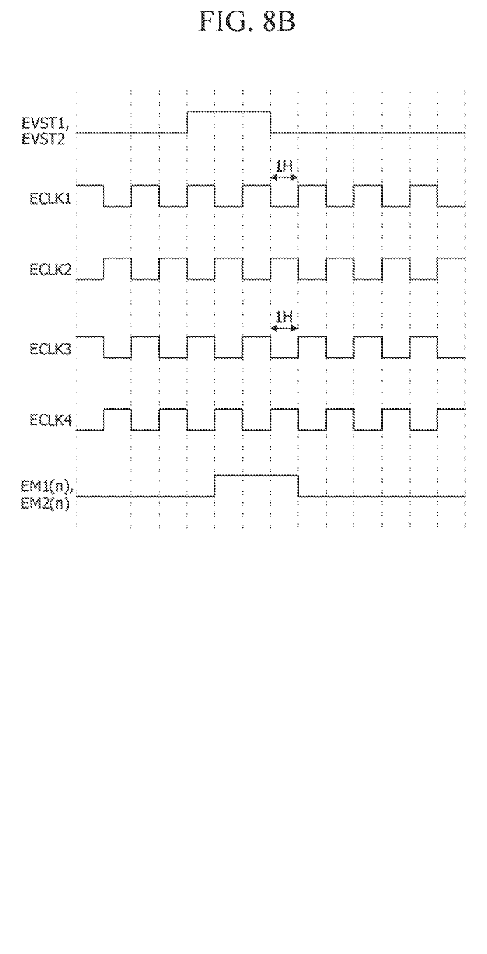

FIGS. 8A and 8B are diagrams for explaining operations of a gate driver according to a second implementation.

Referring to FIGS. 8A and 8B, a gate driver according to the second implementation of the present disclosure may include a plurality of EM drivers EM, and the plurality of EM drivers EM may be connected to different clock lines CL1 and CL2 along column lines.

For example, the plurality of EM drivers EM may include a first EM driver EM1 connected to a first clock line CL1 and a second EM driver EM2 connected to a second clock line CL2.

A first start signal EVST1 and two-phase first clock signals ECLK1 and ECLK2 may be applied to the first EM driver EM1, and a second start signal EVST2 and two-phase second clock signals ECLK3 and ECLK4 may be applied to the second EM driver EM2. The first start signal EVST1 and the second start signal EVST2 may be identical, the first clock signal ECLK1 and the second clock signal ECLK3 may be identical, and the first clock signal ECLK2 and the second clock signal ECLK4 may be identical.

As shown in FIG. 8B, the first start signal EVST1 and the second start signal EVST2 each have a pulse width of 3H and are identical to each other.

In addition, the first clock signals ECLK1 and ECLK3 and the second clock signals ECLK2 and ECLK4 each have a pulse width of 1H, the first clock signals ECLK1 and ECLK2 have a phase difference of 180 degrees from each other, and the second clock signals ECLK3 and ECLK4 have a phase difference of 180 degrees from each other. The first clock signal ECLK1 and the second clock signal ECLK2 may be identical, and the first clock signal ECLK2 and the second clock signal ECLK4 may be identical.

That is, in the second implementation, the same start signal and clock signals are applied to different clock lines.

A plurality of the first and second gate drivers are present in an active area, and since they are connected to different clock lines along column lines, as shown in FIG. 5C, the number of capacitors including the second capacitor C2 and a parasitic capacitor Cpara is reduced by half compared to the number of gate drivers.

In addition, since the clock lines to which four-phase clock signals are applied are separated into two clock lines, the resistance of each clock line is reduced by half.

In the gate driver according to the first implementation, since the clock lines are separated into two clock lines, the number of the resistors and capacitors is reduced, and therefore RC delay of the clock lines is also reduced.

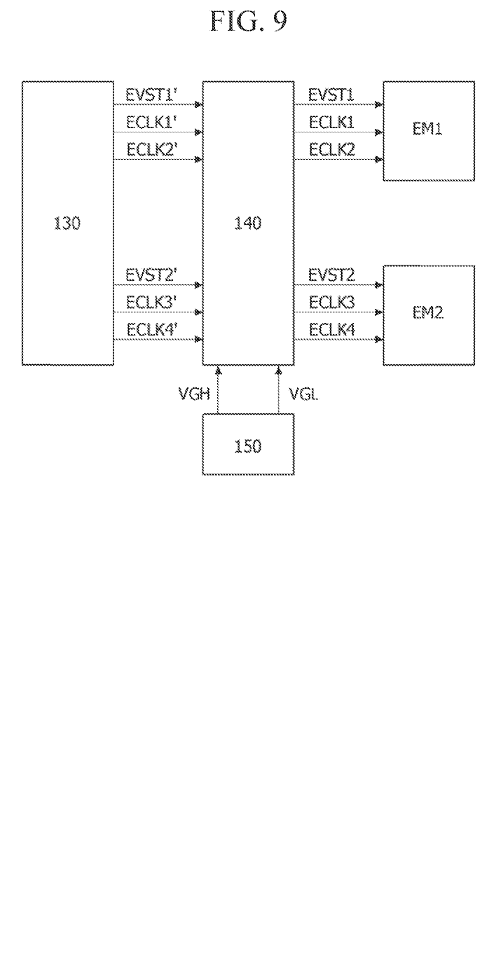

FIG. 9 is a diagram for explaining a principle of generating a clock signal according to the second implementation.

Referring to FIG. 9, a timing controller 130 according to the second implementation generates a first start signal EVST1', first clock signals ECLK1' and ECLK2' to be applied to a first EM driver, and a second start signal EVST2', and second clock signals ECLK3' and ECLK4' to be applied to a second EM driver, and may provide them to a level shifter 140.

The level shifter 140 may amplify the voltage levels of the first start signal EVST1', first clock signals ECLK1' and ECLK2', second start signal EVST2', and second clock signals ECLK3' and ECLK4' provided from the timing controller 130, and supply the amplified first start signal EVST1 and first clock signals ECLK1 and ECLK2 to the first EM driver arranged on a panel 100 through a first clock line, and supply the amplified second start signal EVST2 and second clock signals ECLK3 and ECLK4 to the second EM driver arranged on the panel 100.

In this case, the level shifter 140 may be implemented as a first level shifter that generates the first clock signals and a second level shifter that generates the second clock signals, but is not limited thereto.

A power supply 150 may supply a high-potential voltage VGH and a low-potential voltage VGL to the level shifter 140.

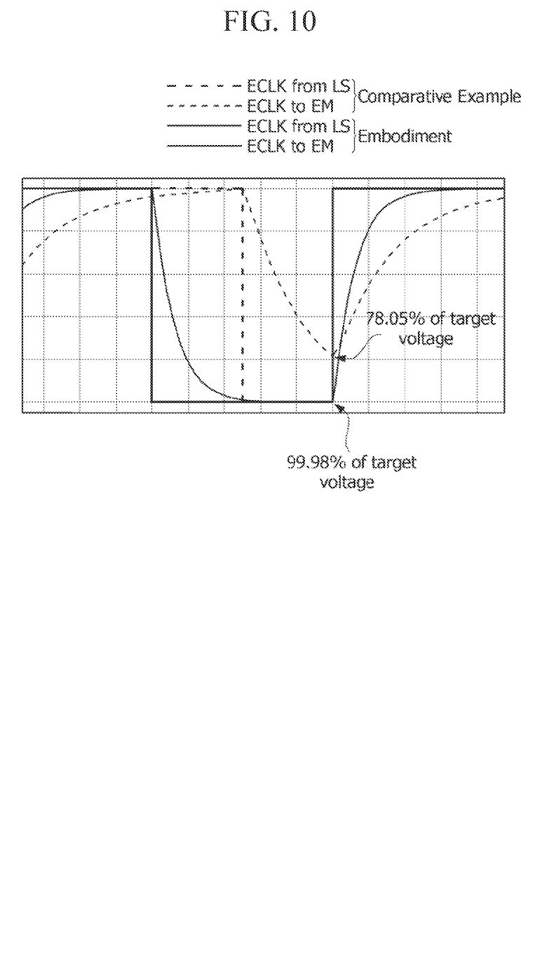

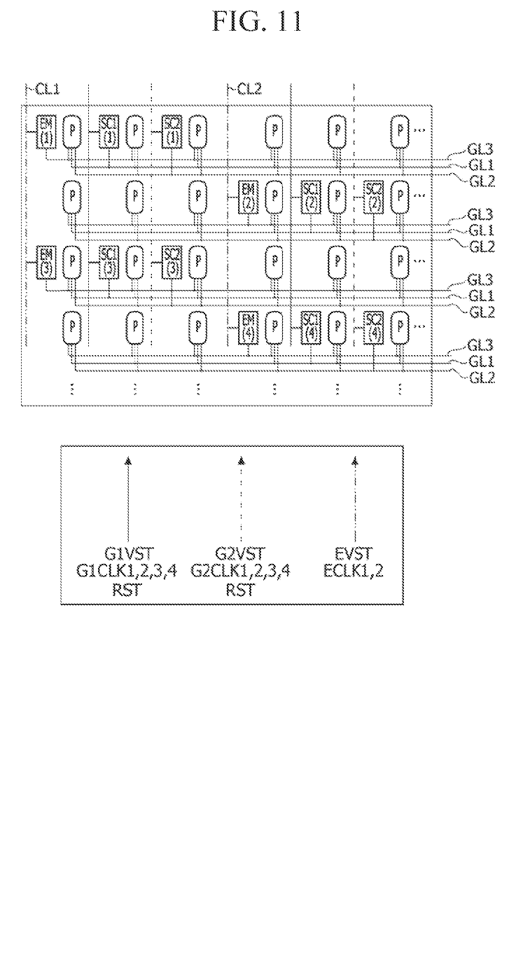

FIG. 10 is a diagram for comparatively explaining simulation results of a comparative example and the implementations.

Referring to FIG. 10, it illustrates waveforms of clock signals in a comparative example, in which the same clock signal ECLK is applied to all EM drivers within a display panel, and in an implementation, in which different clock signals ECLK are applied to EM drivers that are alternately arranged along column lines.

In the comparative example, the clock signal reaches 78.05% of the target voltage, whereas in the implementation, the clock signal reaches 99.98% of the target voltage, indicating that RC delay is reduced.

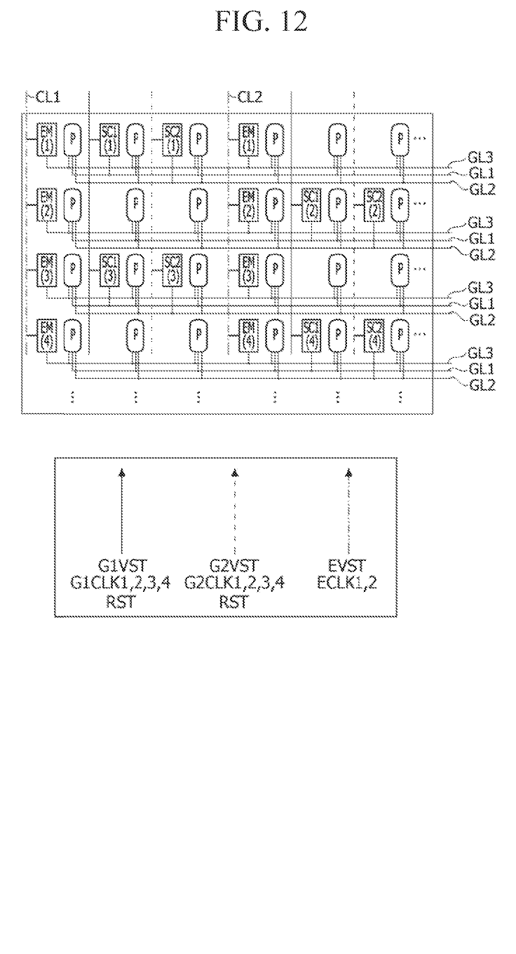

FIGS. 11 and 12 are diagrams showing other arrangement structures of the gate driver.

Referring to FIG. 11, the EM driver EM, the first scan driver SC1, and the second scan driver SC2 may be alternately arranged along column lines for odd-numbered and even-numbered pixel lines.

Referring to FIG. 12, the first scan driver SC1 and the second scan driver SC2 (excluding the EM driver EM) may be alternately arranged along column lines on odd-numbered and even-numbered pixel lines.

A plurality of first scan drivers SC1 for each pixel line may be commonly connected to a first gate line GL1, second scan drivers SC2 may be commonly connected to a second gate line GL2, and EM drivers EM may be commonly connected to a third gate line GL3.

In this configuration, as shown in FIG. 8A, the clock lines for the EM driver EM may be separated along column lines.

Although the implementations of the present disclosure have been described in more detail with reference to the accompanying drawings, the present disclosure is not limited thereto and may be embodied in many different forms without departing from the technical concept of the present disclosure. Therefore, the implementations disclosed in the present disclosure are provided for illustrative purposes only and are not intended to limit the technical concept of the present disclosure. The scope of the technical concept of the present disclosure is not limited thereto. Therefore, it should be understood that the above-described implementations are illustrative in all aspects and do not limit the present disclosure.

1. A display device comprising:
a pixel array in which a plurality of data lines, a plurality of gate lines, and a plurality of pixels are arranged;
a data driver configured to output data voltages to the plurality of data lines;
a gate driver arranged in the pixel array and configured to output gate signals to the plurality of gate lines; and
a level shifter configured to generate first and second clock signals for the gate driver,
wherein the gate driver comprises:
a first gate driver arranged on odd-numbered column lines and configured to receive the first clock signal; and
a second gate driver arranged on even-numbered column lines and configured to receive the second clock signal.

2. The display device of claim 1, further comprising:
a first clock line configured to apply the first clock signal to the first gate driver; and
a second clock line configured to apply the second clock signal to the second gate driver.

3. The display device of claim 2, wherein the first gate driver is arranged on odd-numbered column lines and odd-numbered row lines, and
the second gate driver is arranged on even-numbered column lines and even-numbered row lines.

4. The display device of claim 3, wherein the first clock signal and the second clock signal have different phases.

5. The display device of claim 4, wherein each of the first clock signal and the second clock signal has a pulse width of 2H.

6. The display device of claim 2, wherein the first gate driver is arranged on all row lines of odd-numbered column lines, and
the second gate driver is arranged on all row lines of even-numbered column lines.

7. The display device of claim 6, wherein the first clock signal and the second clock signal have the same phase.

8. The display device of claim 7, wherein each of the first clock signal and the second clock signal has a pulse width of 1H.

9. A display device comprising:
a pixel array in which a plurality of data lines, a plurality of gate lines, and a plurality of pixels are arranged;
a data driver configured to output data voltages to the plurality of data lines;
a scan driver arranged in the pixel array and configured to output scan signals to the plurality of gate lines;
an EM driver arranged in the pixel array and configured to output emission control signals to the plurality of gate lines; and
a level shifter configured to generate clock signals for the scan driver and the EM driver,
wherein the EM driver comprises:
a first EM driver arranged on odd-numbered column lines and configured to receive a first-phase clock signal; and
a second EM driver arranged on even-numbered column lines and configured to receive a second-phase clock signal.

10. The display device of claim 9, further comprising:
a first clock line configured to apply the first-phase clock signal to the first EM driver; and
a second clock line configured to apply the second-phase clock signal to the second EM driver.

11. The display device of claim 10, wherein the first EM driver is arranged on odd-numbered column lines and odd-numbered row lines, and
the second EM driver is arranged on even-numbered column lines and even-numbered row lines.

12. The display device of claim 11, wherein the first-phase clock signal and the second-phase clock signal are four-phase clock signals.

13. The display device of claim 12, wherein each of the first-phase clock signal and the second-phase clock signal has a pulse width of 2H.

14. The display device of claim 10, wherein the first EM driver is arranged on all row lines of odd-numbered column lines, and
the second EM driver is arranged on all row lines of even-numbered column lines.

15. The display device of claim 14, wherein the first-phase clock signal and the second-phase clock signal are two-phase clock signals.

16. The display device of claim 15, wherein each of the first-phase clock signal and the second-phase clock signal has a pulse width of 1H.

17. The display device of claim 9, wherein the EM driver comprises:
a first transistor, a second transistor, a third transistor, a fourth transistor, a fifth transistor, a sixth transistor, a seventh transistor, an eighth transistor, a ninth transistor, a tenth transistor, an eleventh transistor, a twelfth transistor, and a thirteenth transistor, and
a first capacitor, a second capacitor, and a third capacitor,
wherein the first transistor includes a gate electrode to which a second clock signal is applied, a first electrode to which a start signal is applied, and a second electrode connected to a first node;
the second transistor includes a gate electrode to which a first clock signal is applied, a first electrode connected to the first node, and a second electrode connected to a second node;
the third transistor includes a gate electrode connected to a third node, a first electrode connected to the second node, and a second electrode connected to a first power line to which a high-potential voltage is applied;
the fourth transistor includes a gate electrode connected to a second power line to which a low-potential voltage is applied, a first electrode connected to the first node, and a second electrode connected to a first control node;
the fifth transistor includes a gate electrode to which the second clock signal is applied, a first electrode connected to the second power line, and a second electrode connected to the third node;
the sixth transistor includes a gate electrode connected to the first node, a first electrode to which the second clock signal is applied, and a second electrode connected to the third node;
the seventh transistor includes a gate electrode connected to the second power line, a first electrode connected to the third node, and a second electrode connected to a fourth node;
the eighth transistor includes a gate electrode connected to the fourth node, a first electrode to which the first clock signal is applied, and a second electrode connected to a fifth node;
the ninth transistor includes a gate electrode to which the first clock signal is applied, a first electrode connected to the fifth node, and a second electrode connected to a second control node;
the tenth transistor includes a gate electrode connected to the first node, a first electrode connected to the second control node, and a second electrode connected to the first power line;
the eleventh transistor includes a gate electrode connected to the first control node, a first electrode to which the first clock signal is applied, and a second electrode connected to a sixth node;
the twelfth transistor includes a gate electrode connected to the first control node, a first electrode connected to the second power line, and a second electrode connected to an output node;
the thirteenth transistor includes a gate electrode connected to the second control node, a first electrode connected to the output node, and a second electrode connected to the first power line;
the first capacitor is connected between a gate electrode and a source electrode of the eighth transistor;
the second capacitor is connected between a gate electrode of the twelfth transistor and a source electrode of the eleventh transistor; and
the third capacitor is connected between a gate electrode and a source electrode of the thirteenth transistor.
